(19) United States
(12) Patent Application Publication
(10) Pub. No.: US 2024/0030527 A1
(43) Pub. Date: Jan. 25, 2024

(54) BATTERY

(71) Applicant: Prime Planet Energy & Solutions, Inc., Tokyo (JP)

(72) Inventor: Ichirou MURATA, Setsu-shi (JP)

(21) Appl. No.: 18/356,172

(22) Filed: Jul. 20, 2023

(30) Foreign Application Priority Data
Jul. 22, 2022 (JP) 2022-117265

(51) Int. Cl. H01M 50/183; H01M 50/553; H01M 50/30; H01M 50/15

(52) U.S. Cl. CPC H01M 50/183; H01M 50/553; H01M 50/30; H01M 50/15; H01M 2220/20

(57) ABSTRACT

A battery disclosed herein includes a battery case, an electrode body, a current collecting unit that is connected to a positive electrode or a negative electrode inside the battery case and includes a second through hole, a resin member that is disposed between the battery case and the current collecting unit and includes a first through hole, and a terminal that is inserted into the first through hole and the second through hole and has one end electrically connected to the current collecting unit inside the battery case. The resin member includes a first region provided on a peripheral edge of the first through hole and a second region provided on an outer peripheral side of the first region and formed with the first region integrally. A first material of the first region has a higher melting point than a second material of the second region.

### CROSS REFERENCE TO RELATED APPLICATION

This application claims the benefit of priority to Japanese Patent Application No. 2022-117265 filed on Jul. 22, 2022. The entire contents of this application are hereby incorporated herein by reference.

### BACKGROUND OF THE DISCLOSURE

### 1. Field

The present disclosure relates to a battery.

### 2. Background

A structure of a battery typically includes an electrode body that includes an electrode, a battery case that accommodates the electrode body, a current collecting unit that is disposed inside the battery case and electrically connected to the electrode, and a terminal that is electrically connected to the current collecting unit inside the battery case and attached to the battery case. Conventional technical literatures related to the battery include Japanese Patent Application Publication No. 2022-074817, Japanese Patent No. 5182568, Japanese Patent Application Publication No. 2021-77518, and Japanese Patent Application Publication No. 2013-134869. For example, Japanese Patent Application Publication No. 2022-074817 discloses a battery that further includes a resin member disposed between a sealing plate of a battery case and a current collecting unit, and a terminal is inserted into each of through holes of the current collecting unit and the resin member and mechanically fixed (specifically, fixed by caulking) to the sealing plate.

### SUMMARY

A battery that is charged and discharged at high output and a high rate easily generates heat (especially in a vicinity of a terminal to which current concentrates) in the normal use (charging and discharging). In addition to mechanically fixing the terminal to a sealing plate, the terminal and a current collecting unit may be bonded by metallurgical bonding such as welding. In this case, it is necessary to prevent a resin member in contact with the terminal from being burnt and melted by a heat effect. Thus, the resin member is generally formed of a resin with high heat resistance. According to examinations by the present inventor, however, the resin member formed of the resin with the high heat resistance is fragile and has low impact resistance. As a result, when a large impact, vibration, or the like due to the drop or the like is applied to the resin member during the use of the battery, an electrode body may collide with the resin member and the resin member may be broken. Therefore, the electrode body may be damaged and a short circuit may occur.

The present disclosure has been made in view of the above circumstances and an object of the present disclosure is to provide a battery including a resin member in which a heat effect does not occur easily and impact resistance is improved.

The present disclosure provides a battery including an electrode body that includes a positive electrode and a negative electrode, a battery case that accommodates the electrode body, a current collecting unit that is disposed inside the battery case and electrically connected to the positive electrode or the negative electrode, a terminal that is electrically connected to the current collecting unit inside the battery case and attached to the battery case, and a resin member that is disposed between an inner surface of the battery case and the electrode body. The resin member includes a first through hole. The current collecting unit includes a second through hole. The terminal includes a shaft portion that is inserted into the first through hole and the second through hole, and a bonding portion at one end of the terminal, the bonding portion being bonded to the current collecting unit. The resin member includes a first region that is provided on a peripheral edge of the first through hole and a second region that is provided on an outer peripheral side of the first region and formed with the first region integrally. A first material of the first region has a higher melting point than a second material of the second region.

The resin member includes the different materials depending on the regions. That is to say, the first region that is provided on the peripheral edge of the first through hole is formed of the material whose melting point is higher than that of the second region. Thus, burning and melting of the resin member due to a heat effect can be suppressed. Moreover, the second region that is provided on the outer peripheral side of the first region is formed of the material whose melting point is lower than that of the first region. Thus, the impact resistance of the resin member can be improved relatively compared with a case where the second region and the first region are formed of the materials whose melting points are the same, and a case where the second region is formed of the material whose melting point is higher than that of the first region. Therefore, even if the electrode body collides with the resin member during the use of the battery, the resin member is not easily broken and the damage of the electrode body can be suppressed.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically showing a battery according to an embodiment;

FIG. 2 is a schematic longitudinal cross-sectional view along a line II-II in FIG. 1;

FIG. 3 is a schematic longitudinal cross-sectional view along a line in FIG. 1;

FIG. 4 is a schematic lateral cross-sectional view along a line IV-IV in FIG. 1;

FIG. 5 is a perspective view schematically showing an electrode body group attached to a sealing plate;

FIG. 6 is a perspective view schematically showing an electrode body to which a positive electrode second current collecting unit and a negative electrode second current collecting unit are attached;

FIG. 7 is a schematic view showing a configuration of a winding electrode body;

FIG. 8 is a perspective view schematically showing a sealing plate assembly;

FIG. 9 is a perspective view of the sealing plate in FIG. 8 which is turned over;

FIG. 10 is a cross-sectional view taken along a line X-X in FIG. 8;

FIG. 11 is an exploded view of FIG. 10, schematically showing each member before caulking;

FIG. 12 is a perspective view schematically showing a positive electrode resin member;

FIG. 13 is a cross-sectional view taken along a line XIII-XIII in FIG. 12; and

FIG. 14A to FIG. 14E show modifications in accordance with FIG. 13.

### DETAILED DESCRIPTION OF THE PREFERRED EMBODIMENTS

Hereinafter, some preferred embodiments of a technique disclosed herein will be described with reference to the drawings. Meanwhile, matters other than those particularly mentioned in the present specification and necessary for implementing the present disclosure (for example, general configurations and manufacturing processes of a battery which do not characterize the present disclosure) can be ascertained as a design matter of one skilled in the art based on the conventional art in the relevant field. The present disclosure can be implemented on the basis of the contents disclosed in the present specification and common general technical knowledge in the relevant field.

Meanwhile, in the present specification, “battery” is a term that refers to a general power storage device capable of extracting electric energy, and refers to a concept that includes a primary battery and a secondary battery. In the present specification, “secondary battery” is a term that refers to a general power storage device capable of being repeatedly charged and discharged by transfer of charge carriers between a positive electrode and a negative electrode through an electrolyte. The electrolyte may be any one of a liquid electrolyte (electrolytic solution), a gel electrolyte, and a solid electrolyte. The secondary battery includes so-called storage batteries (chemical batteries) such as lithium ion secondary batteries and nickel-hydrogen batteries, and moreover includes capacitors (physical batteries) such as electrical double-layer capacitors.

<Battery 100>

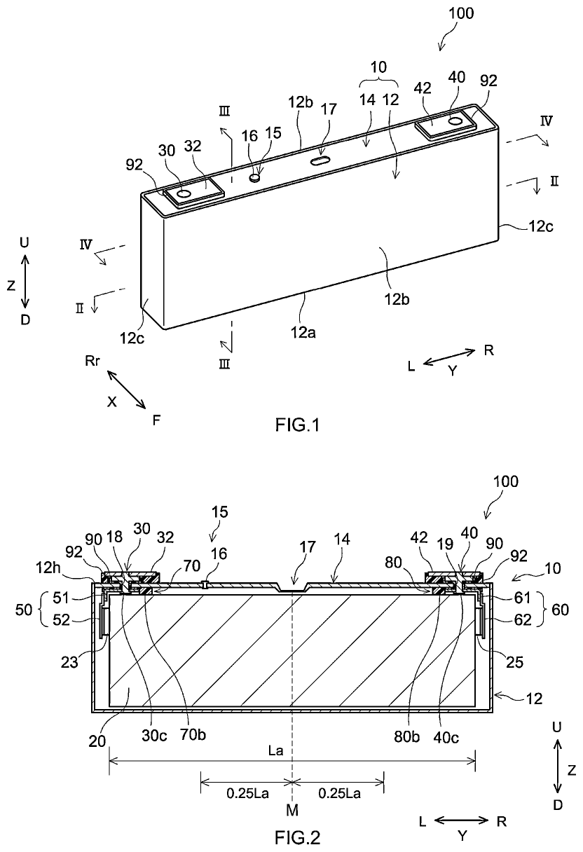

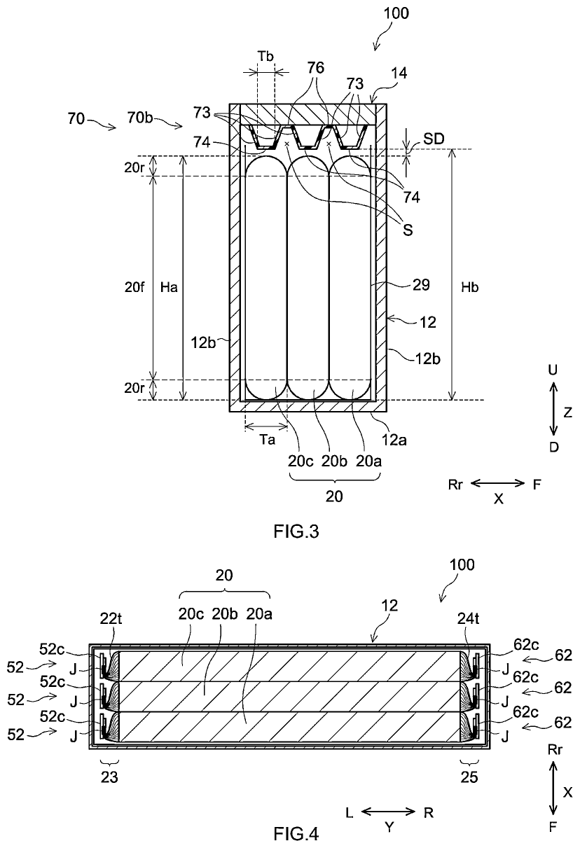

FIG. 1 is a perspective view of a battery 100. FIG. 2 is a schematic longitudinal cross-sectional view along a line in FIG. 1. FIG. 3 is a schematic longitudinal cross-sectional view along a line in FIG. 1. FIG. 4 is a schematic lateral cross-sectional view along a line IV-IV in FIG. 1. Meanwhile, in the following description, signs L, R, F, Rr, U, and D in the drawing represent left, right, front, back, up, and down, and signs X, Y, and Z in the drawing represent a short side direction of the battery 100, a long side direction perpendicular to the short side direction, and an up-down direction, respectively. However, these are merely directions for convenience of description and do not limit the form of installation of the battery 100.

As shown in FIG. 2, the battery 100 includes a battery case 10, an electrode body group 20, a positive electrode terminal 30, a negative electrode terminal 40, a positive electrode current collecting unit 50, a negative electrode current collecting unit 60, a positive electrode resin member 70, and a negative electrode resin member 80. Although not shown in the drawing, the battery 100 further includes an electrolytic solution here. The battery 100 here is a lithium ion secondary battery. The battery 100 is characterized by including the positive electrode resin member 70 and/or the negative electrode resin member 80 disclosed herein, and other configurations may be the same as those in the related art. The positive electrode terminal 30 and the negative electrode terminal 40 are examples of terminals disclosed herein. The positive electrode resin member 70 and the negative electrode resin member 80 are examples of resin members disclosed herein.

The battery case 10 is a housing that accommodates the electrode body group 20. Here, the battery case 10 has an outward form having a flat and bottomed rectangular parallelepiped shape (square shape). The material of the battery case 10 may be the same as a material that has been used hitherto, and is not particularly limited. The battery case 10 is preferably formed of a metal and is more preferably formed of, for example, aluminum, an aluminum alloy, iron, an iron alloy, or the like. As shown in FIG. 2, the battery case 10 includes an exterior body 12 having an opening 12h, and a sealing plate (lid) 14 that covers the opening 12h.

As shown in FIG. 1, the exterior body 12 includes a bottom wall 12a with a substantially rectangular shape, a pair of long side walls 12b that extend from long sides of the bottom wall 12a and face each other, and a pair of short side walls 12c that extend from short sides of the bottom wall 12a and face each other. The bottom wall 12a faces the opening 12h. The area of the short side wall 12c is smaller than the area of the long side wall 12b. The sealing plate 14 is attached to the exterior body 12 to block the opening 12h of the exterior body 12. The sealing plate 14 faces the bottom wall 12a of the exterior body 12. The sealing plate 14 has a substantially rectangular shape when seen in a plan view. The battery case 10 is integrated by the sealing plate 14 being bonded to a peripheral edge of the opening 12h of the exterior body 12 (for example, welding bonding). The battery case 10 is airtightly sealed (closed).

As shown in FIG. 2, the sealing plate 14 is provided with a liquid injection hole 15, a gas exhaust valve 17, and two terminal draw-out holes 18 and 19. The liquid injection hole is a hole for injecting an electrolytic solution after the sealing plate 14 is assembled to the exterior body 12. The liquid injection hole 15 is sealed by a sealing member 16. The gas exhaust valve 17 is configured to fracture when pressure inside the battery case 10 reaches a predetermined value or more and discharge a gas in the battery case 10 to the outside. The terminal draw-out holes 18 and 19 are formed in both ends of the sealing plate 14 in the long side direction Y. The terminal draw-out holes 18 and 19 penetrate the sealing plate 14 in the up-down direction Z. The terminal draw-out holes 18 and 19 respectively have inner diameters that enable penetration of the positive electrode terminal 30 and the negative electrode terminal 40 before the electrode terminals are attached to the sealing plate 14 (before caulking).

The positive electrode terminal 30 and the negative electrode terminal 40 are attached to the battery case 10. It is preferable that the positive electrode terminal 30 and the negative electrode terminal 40 be attached to the sealing plate 14 that forms the battery case 10. The positive electrode terminal 30 is disposed on one side of the sealing plate 14 in the long side direction Y (the left side in FIGS. 1 and 2). The negative electrode terminal 40 is disposed on the other side of the sealing plate 14 in the long side direction Y (the right side in FIGS. 1 and 2). As shown in FIG. 1, the positive electrode terminal 30 and the negative electrode terminal are exposed through an outer surface of the sealing plate 14. As shown in FIG. 2, the positive electrode terminal 30 and the negative electrode terminal 40 are inserted into the terminal draw-out holes 18 and 19 and extend from the inside to the outside of the sealing plate 14. It is preferable that the positive electrode terminal 30 and the negative electrode terminal 40 penetrate the terminal draw-out holes 18 and 19 of the sealing plate 14. Here, the positive electrode terminal 30 and the negative electrode terminal 40 are caulked to a peripheral edge portion of the sealing plate 14 which surrounds the terminal draw-out holes 18 and 19 by caulking. Caulking portions 30c and 40c are formed at ends of the positive electrode terminal 30 and the negative electrode terminal 40 on the exterior body 12 side (a lower end portion in FIG. 2). It is preferable that the positive electrode terminal 30 and the negative electrode terminal 40 include the caulking portions 30c and 40c at the ends thereof

As shown in FIG. 2, the positive electrode terminal 30 is electrically connected to a positive electrode 22 of the electrode body group 20 through the positive electrode current collecting unit 50 inside the battery case 10. The negative electrode terminal 40 is electrically connected to a negative electrode 24 of the electrode body group 20 through the negative electrode current collecting unit 60 inside the battery case 10. The positive electrode terminal 30 is insulated from the sealing plate 14 by the positive electrode resin member 70 and a gasket 90. The negative electrode terminal 40 is insulated from the sealing plate 14 by the negative electrode resin member 80 and the gasket 90.

The positive electrode terminal 30 is preferably formed of a metal and is more preferably formed of, for example, aluminum or an aluminum alloy. The negative electrode terminal 40 is preferably formed of a metal and is more preferably formed of, for example, copper or a copper alloy. The negative electrode terminal 40 may be configured of two conductive members bonded together and integrated. For example, a portion connected to the negative electrode current collecting unit 60 may be formed of copper or a copper alloy, and a portion exposed through the outer surface of the sealing plate 14 may be formed of aluminum or an aluminum alloy.

As shown in FIG. 1, plate-shaped positive electrode external conductive member 32 and negative electrode external conductive member 42 are attached to the outer surface of the sealing plate 14. The positive electrode external conductive member 32 is electrically connected to the positive electrode terminal 30. The negative electrode external conductive member 42 is electrically connected to the negative electrode terminal 40. The positive electrode external conductive member 32 and the negative electrode external conductive member 42 are members to which a bus bar is attached when a plurality of batteries 100 are electrically connected to each other. The positive electrode external conductive member 32 and the negative electrode external conductive member 42 are preferably formed of a metal and are more preferably formed of, for example, aluminum or an aluminum alloy. The positive electrode external conductive member 32 and the negative electrode external conductive member 42 are insulated from the sealing plate 14 by an external resin member 92. However, the positive electrode external conductive member 32 and the negative electrode external conductive member 42 are not essential members, and can also be omitted in other embodiments.

FIG. 5 is a perspective view schematically showing the electrode body group 20 attached to the sealing plate 14. Here, the electrode body group 20 includes three electrode bodies 20a, 20b, and 20c. However, the number of electrode bodies disposed inside one battery case 10 is not particularly limited, and may be two or more (plural) or may be one. The electrode body group 20 is covered with an electrode body holder 29 (see FIG. 3) constituted by a resin sheet and disposed inside the battery case 10.

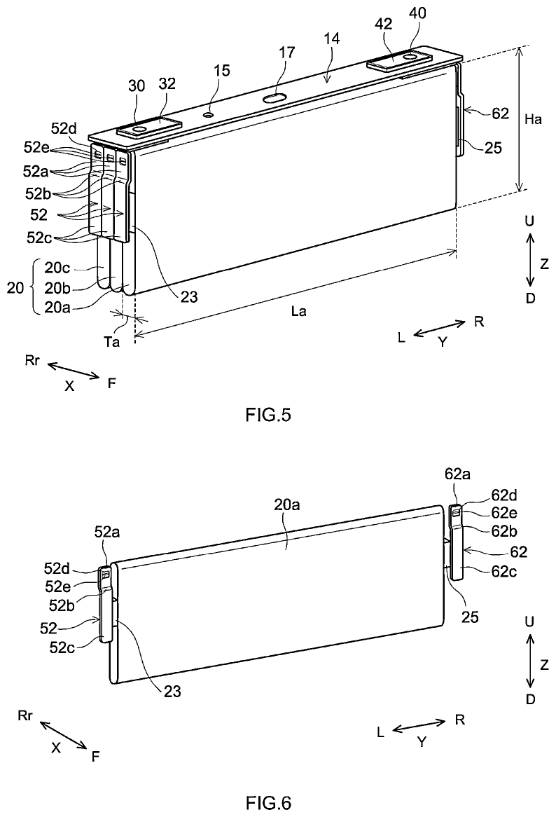

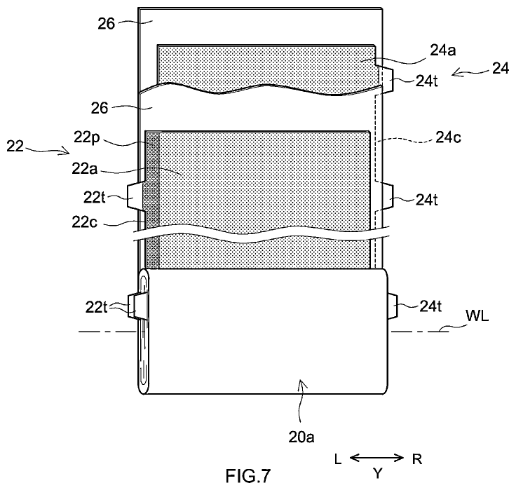

FIG. 6 is a perspective view schematically showing the electrode body 20a. FIG. 7 is a schematic view showing a configuration of the electrode body 20a. Meanwhile, detailed description will be given below with the electrode body 20a as an example, but the electrode bodies 20b and 20c can also be configured in the same manner. As shown in FIG. 7, the electrode body 20a includes the positive electrode 22 and the negative electrode 24. Here, the electrode body 20a is a flat winding electrode body in which the band-like positive electrode 22 and the band-like negative electrode 24 are laminated through a band-like separator 26 and are wound centering on a winding axis WL.

As shown in FIG. 2 and FIG. 7, the electrode body 20a is disposed inside the battery case 10 in a direction in which the winding axis WL is parallel to the long side direction Y. In other words, the electrode body 20a is disposed inside the battery case 10 in a direction in which the winding axis WL is parallel to the bottom wall 12a and perpendicular to the short side wall 12c. Both end faces of the electrode body 20a (in other words, a lamination surface on which the positive electrode 22 and the negative electrode 24 are laminated, and both end faces in the long side direction Yin FIG. 7) face the short side walls 12c. The battery 100 has a so-called lateral tab structure in which a positive electrode tab group 23 and a negative electrode tab group 25 exist on a left side and a right side of the electrode body group 20. However, the battery 100 may have a so-called upper tab structure in which the positive electrode tab group 23 and the negative electrode tab group 25 exist on an upper side and a lower side of the electrode body group 20.

As shown in FIG. 3, the electrode body 20a includes a pair of curved portions 20r facing the bottom wall 12a of the exterior body 12 and the sealing plate 14, and a flat portion connecting the pair of curved portions 20r and facing the long side walls 12b of the exterior body 12. However, the electrode body 20a may be a laminated electrode body in which a plurality of square (typically, rectangular) positive electrodes and a plurality of square (typically, rectangular) negative electrodes are laminated on each other in an insulated state.

As shown in FIG. 7, the positive electrode 22 includes a positive electrode current collector 22c, and a positive electrode active material layer 22a and a positive electrode protection layer 22p which are firmly fixed onto at least one surface of the positive electrode current collector 22c. However, the positive electrode protection layer 22p is not an essential component and can also be omitted in other embodiments. The positive electrode current collector 22c has a band shape. The positive electrode current collector 22c is formed of a conductive metal such as aluminum, an aluminum alloy, nickel, or stainless steel. Here, the positive electrode current collector 22c is a metal foil, specifically an aluminum foil.

A plurality of positive electrode tabs 22t are provided at one end (the left end in FIG. 7) of the positive electrode current collector 22c in the long side direction Y. Each of the plurality of positive electrode tabs 22t protrudes toward one side (the left side in FIG. 7) in the long side direction Y. The plurality of positive electrode tabs 22t protrude from the separator 26 in the long side direction Y. The plurality of positive electrode tabs 22t are provided at intervals (intermittently) in the longitudinal direction of the positive electrode 22. Each of the plurality of positive electrode tabs 22t has a trapezoidal shape. Here, the positive electrode tab 22t is a portion of the positive electrode current collector 22c and is formed of a metal foil (aluminum foil). Here, the positive electrode tab 22t is a portion (current collector exposing portion) of the positive electrode current collector 22c in which the positive electrode active material layer 22a and the positive electrode protection layer 22p are not formed. However, the positive electrode tab 22t may be a member separate from the positive electrode current collector 22c. In addition, the positive electrode tabs 22t may be provided at the other end (the right end in FIG. 7) in the long side direction Y or may be provided at both ends in the long side direction Y.

As shown in FIG. 4, the plurality of positive electrode tabs 22t are laminated at one end (the left end in FIG. 4) in the long side direction Y and constitute the positive electrode tab group 23. The plurality of positive electrode tabs 22t are bent and curved such that outer ends thereof are aligned. It is preferable that the plurality of positive electrode tabs 22t be bent and electrically connected to the positive electrode terminal 30. The size of each of the plurality of positive electrode tabs 22t (the length in the long side direction Y and the width perpendicular to the long side direction Y, see FIG. 7) can be appropriately adjusted in accordance with, for example, its formation position or the like in consideration of a state where the positive electrode tabs 22t are connected to the positive electrode current collecting unit 50. Although not shown in the drawing, here, the plurality of positive electrode tabs 22t have different sizes so that the outer ends thereof are aligned when they are curved. As shown in FIG. 2, the positive electrode tab group 23 is electrically connected to the positive electrode terminal 30 through the positive electrode current collecting unit 50. A positive electrode second current collecting unit 52 to be described later is attached to the positive electrode tab group 23.

As shown in FIG. 7, the positive electrode active material layer 22a is provided to have a band shape in the longitudinal direction of the band-like positive electrode current collector 22c. The positive electrode active material layer 22a contains a positive electrode active material (for example, a lithium transition metal composite oxide such as a lithium nickel cobalt manganese composite oxide) capable of reversibly occluding and releasing charge carriers. When a total solid content of the positive electrode active material layer 22a is defined as 100% by mass, the positive electrode active material may occupy approximately 80% or more by mass, typically 90% or more by mass, and for example, 95% or more by mass. The positive electrode active material layer 22a may contain any component other than the positive electrode active material, for example, a conductive material, a binder, various additive components, or the like. As the conductive material, a carbon material such as acetylene black (AB) can be used. As the binder, for example, polyvinylidene fluoride (PVdF) or the like can be used.

As shown in FIG. 7, the positive electrode protection layer 22p is provided at a boundary portion between the positive electrode current collector 22c and the positive electrode active material layer 22a in the long side direction Y. Here, the positive electrode protection layer 22p is provided at one end (the left end in FIG. 7) of the positive electrode current collector 22c in the long side direction Y. However, the positive electrode protection layer 22p may be provided at both ends in the long side direction Y. The positive electrode protection layer 22p is formed in a band shape along the positive electrode active material layer 22a. The positive electrode protection layer 22p contains an inorganic filler (for example, alumina). When a total solid content of the positive electrode protection layer 22p is defined as 100% by mass, the inorganic filler may occupy approximately 50% or more by mass, typically 70% or more by mass, and for example, 80% or more by mass. The positive electrode protection layer 22p may contain any component other than the inorganic filler, for example, a conductive material, a binder, various additive components, or the like. The conductive material and the binder may be the same as those exemplified as being able to be contained in the positive electrode active material layer 22a.

As shown in FIG. 7, the negative electrode 24 includes a negative electrode current collector 24c and a negative electrode active material layer 24a which is firmly fixed onto at least one surface of the negative electrode current collector 24c. The negative electrode current collector 24c has a band shape. The negative electrode current collector 24c is formed of a conductive metal such as copper, a copper alloy, nickel, or stainless steel. Here, the negative electrode current collector 24c is a metal foil, specifically a copper foil.

A plurality of negative electrode tabs 24t are provided at one end (the right end in FIG. 7) of the negative electrode current collector 24c in the long side direction Y. Each of the plurality of negative electrode tabs 24t protrudes toward one side (the right side in FIG. 7) in the long side direction Y. The plurality of negative electrode tabs 24t protrude from the separator 26 in the long side direction Y. The plurality of negative electrode tabs 24t are provided at intervals (intermittently) in the longitudinal direction of the negative electrode 24. Each of the plurality of negative electrode tabs 24t has a trapezoidal shape. Here, the negative electrode tab 24t is a portion of the negative electrode current collector 24c and is formed of a metal foil (copper foil). Here, the negative electrode tab 24t is a portion (current collector exposing portion) of the negative electrode current collector 24c in which the negative electrode active material layer 24a is not formed. However, the negative electrode tab 24t may be a member separate from the negative electrode current collector 24c. In addition, the negative electrode tab 24t may be provided at the other end (the left end in FIG. 7) in the long side direction Y or may be provided at both ends in the long side direction Y.

As shown in FIG. 4, the plurality of negative electrode tabs 24t are laminated at one end (the right end in FIG. 4) in the long side direction Y and constitute the negative electrode tab group 25. The plurality of negative electrode tabs 24t are bent and curved such that outer ends thereof are aligned. It is preferable that the plurality of negative electrode tabs 24t be bent and electrically connected to the negative electrode terminal 40. The size of each of the plurality of negative electrode tabs 24t (the length in the long side direction Y and the width perpendicular to the long side direction Y, see FIG. 7) can be appropriately adjusted in accordance with, for example, its formation position or the like in consideration of a state where the negative electrode tabs 24t are connected to the negative electrode current collecting unit 60. Although not shown in the drawing, here, the plurality of negative electrode tabs 24t have different sizes so that the outer ends thereof are aligned when they are curved. As shown in FIG. 2, the negative electrode tab group 25 is electrically connected to the negative electrode terminal 40 through the negative electrode current collecting unit 60. A negative electrode second current collecting unit 62 to be described later is attached to the negative electrode tab group 25.

As shown in FIG. 7, the negative electrode active material layer 24a is provided to have a band shape in the longitudinal direction of the band-like negative electrode current collector 24c. The negative electrode active material layer 24a contains a negative electrode active material (for example, a carbon material such as graphite) capable of reversibly occluding and releasing charge carriers. When a total solid content of the negative electrode active material layer 24a is set to 100% by mass, the negative electrode active material may occupy approximately 80% or more by mass, typically 90% or more by mass, and for example, 95% or more by mass. The negative electrode active material layer 24a may contain any component other than the negative electrode active material, for example, a binder, a dispersing agent, various additive components, or the like. As the binder, rubbers such as styrene-butadiene rubber (SBR) can be used. As the dispersing agent, celluloses such as carboxymethyl cellulose (CMC) can be used.

The separator 26 is a member that insulates the positive electrode active material layer 22a of the positive electrode 22 and the negative electrode active material layer 24a of the negative electrode 24 from each other. As the separator 26, a porous resin sheet formed of a polyolefin resin such as polyethylene (PE) or polypropylene (PP) is suitable. Meanwhile, a heat resistance layer (HRL) containing an inorganic filler may be provided on a surface of the separator 26. As the inorganic filler, for example, alumina, boehmite, aluminum hydroxide, titania, and the like can be used.

An electrolytic solution may be the same as that in the related art and is not particularly limited. The electrolytic solution is, for example, a non-aqueous electrolytic solution containing a non-aqueous solvent and a supporting salt. The non-aqueous solvent contains carbonates such as ethylene carbonate, dimethyl carbonate, and ethyl methyl carbonate. The supporting salt is a fluorine-containing lithium salt such as LiPF₆. However, the electrolytic solution may be in a solid state (solid electrolyte) and integrated with the electrode body group 20.

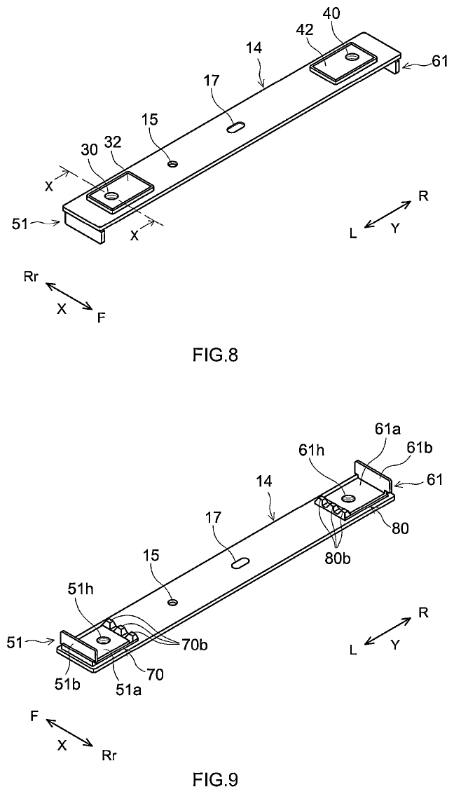

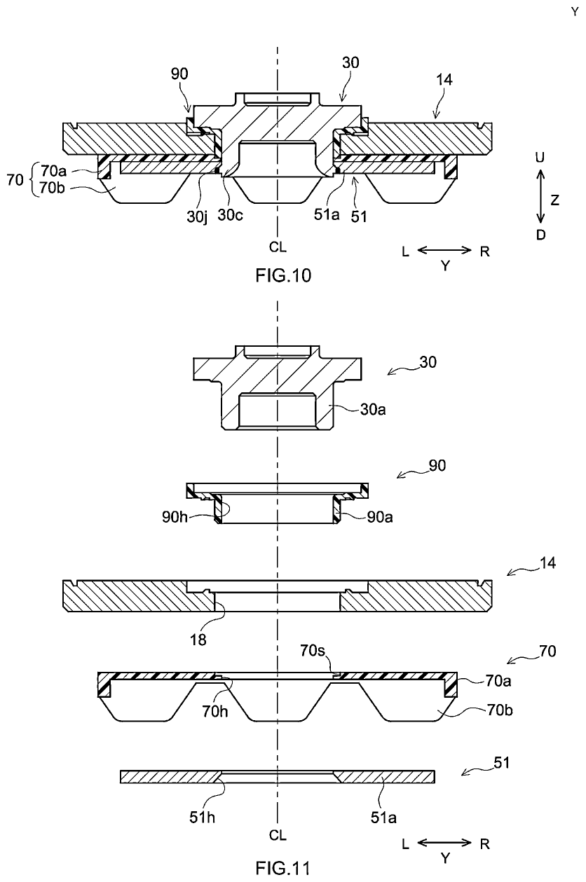

FIG. 8 is a perspective view schematically showing a united object in which the positive electrode terminal 30, the negative electrode terminal 40, a positive electrode first current collecting unit 51 of the positive electrode current collecting unit 50, a negative electrode first current collecting unit 61 of the negative electrode current collecting unit 60, the positive electrode resin member 70, and the negative electrode resin member 80 are attached to a sealing plate assembly, that is, the sealing plate 14. FIG. 9 is a perspective view of the sealing plate 14 in FIG. 8 which is turned over. FIG. 9 shows a surface of the sealing plate 14 on the side of exterior body 12 (the inner side). FIG. 10 is a cross-sectional view taken along a line X-X in FIG. 8 and a partially enlarged cross-sectional view schematically showing the surroundings of the positive electrode terminal 30. FIG. 11 is an exploded view of FIG. 10, schematically showing each member before caulking. Note that in FIG. 10 and FIG. 11, a center line CL of the positive electrode terminal 30 is expressed by a dash-dotted line. In addition, the positive electrode external conductive member 32 and the external resin member 92 are omitted in the drawings.

The positive electrode current collecting unit 50 is disposed inside the battery case 10. The positive electrode current collecting unit 50 constitutes a conductive path that electrically connects the positive electrode tab group 23 constituted by the plurality of positive electrode tabs 22t and the positive electrode terminal 30. As shown in FIG. 2, the positive electrode current collecting unit 50 includes the positive electrode first current collecting unit 51 and the positive electrode second current collecting unit 52. The positive electrode first current collecting unit 51 is an example of a current collecting unit disclosed herein. The positive electrode first current collecting unit 51 and the positive electrode second current collecting unit 52 may be formed of the same metal species as the positive electrode current collector 22c, for example, a conductive metal such as aluminum, an aluminum alloy, nickel, or stainless steel.

As shown in FIG. 9, the positive electrode first current collecting unit 51 is attached to the inner surface of the sealing plate 14. The positive electrode first current collecting unit 51 includes a first portion 51a and a second portion 51b. The positive electrode first current collecting unit 51 may be configured by bending one member by, for example, press working or the like, or may be configured by integrating a plurality of members by welding bonding or the like. Here, the positive electrode first current collecting unit 51 is fixed to the sealing plate 14 by caulking.

In the positive electrode first current collecting unit 51, the first portion 51a is a part disposed between the sealing plate 14 and the electrode body group 20. The first portion 51a extends in the long side direction Y. The first portion 51a extends horizontally along the inner surface of the sealing plate 14. The positive electrode resin member 70 is disposed between the sealing plate 14 and the first portion 51a. The first portion 51a is insulated from the sealing plate 14 by the positive electrode resin member 70. Here, the first portion 51a is electrically connected to the positive electrode terminal 30 by caulking. As shown in FIG. 11, in the first portion 51a, a through hole 51h penetrating in the up-down direction Z is formed at a position corresponding to the terminal draw-out hole 18 of the sealing plate 14. The through hole 51h is formed in a tapered shape in which the diameters thereof become smaller toward the side of the sealing plate 14 (the upper side in FIG. 11). Into the through hole 51h, a shaft portion 30a of the positive electrode terminal 30 is inserted. The shaft portion 30a here penetrates the through hole 51h. However, the shaft portion 30a does not need to penetrate the through hole 51h completely. The through hole 51h is an example of a second through hole disclosed herein.

In the positive electrode first current collecting unit 51, the second portion 51b is a part disposed between the short side wall 12c of the exterior body 12 and the electrode body group 20. The second portion 51b extends from one end of the first portion 51a in the long side direction Y (the left end in FIG. 9) to the short side wall 12c of the exterior body 12. The second portion 51b extends in the up-down direction Z.

As shown in FIG. 10, the positive electrode first current collecting unit 51 is bonded to the caulking portion 30c of the positive electrode terminal 30. At a boundary portion between the caulking portion 30c and the positive electrode first current collecting unit 51, a bonding portion 30j is formed. It is preferable that at a boundary portion between the positive electrode terminal 30 and the positive electrode first current collecting unit 51, the bonding portion 30j be formed. The bonding portion 30j here has a circular shape. The bonding portion 30j is typically a metallurgical bonding portion and preferably a welding bonding portion. Thus, the electric connection between the positive electrode terminal 30 and the positive electrode current collecting unit 50 can be stably kept and the conduction reliability can be improved.

As shown in FIG. 5 and FIG. 6, the positive electrode second current collecting unit 52 extends along the short side wall 12c of the exterior body 12. As shown in FIG. 6, the positive electrode second current collecting unit 52 includes a current collector plate connection portion 52a, an inclined portion 52b, and a tab bonding portion 52c. The current collector plate connection portion 52a is a part which is electrically connected to the positive electrode first current collecting unit 51. The current collector plate connection portion 52a extends in the up-down direction Z. The current collector plate connection portion 52a is disposed to be substantially perpendicular to the winding axis WL of the electrode bodies 20b, and 20c. The current collector plate connection portion 52a is provided with a concave portion 52d having a thickness smaller than the periphery thereof. The concave portion 52d is provided with a through hole 52e penetrating in the short side direction X. Although not shown in the drawing, a bonding portion for the positive electrode first current collecting unit 51 is formed in the through hole 52e. The bonding portion is a welding bonding portion formed by welding such as ultrasonic welding, resistance welding, or laser welding. The positive electrode second current collecting unit 52 may be provided with a fuse.

The tab bonding portion 52c is a part which is attached to the positive electrode tab group 23 and electrically connected to the plurality of positive electrode tabs 22t. As shown in FIG. 5, the tab bonding portion 52c extends in the up-down direction Z. The tab bonding portion 52c is disposed to be substantially perpendicular to the winding axis WL of the electrode bodies 20a, 20b, and 20c. A surface of the tab bonding portion 52c which is connected to the plurality of positive electrode tabs 22t is disposed to be substantially parallel to the short side wall 12c of the exterior body 12. As shown in FIG. 4, a bonding portion J for the positive electrode tab group 23 is formed in the tab bonding portion 52c. The bonding portion J is a welding bonding portion which is formed by welding such as ultrasonic welding, resistance welding, or laser welding, for example, in a state where the plurality of positive electrode tabs 22t overlap each other. In the bonding portion J, the plurality of positive electrode tabs 22t are disposed to be close to one side of the electrode bodies 20a, 20b, and 20c in the short side direction X. Thereby, it is possible to stably form the curved positive electrode tab group 23 as shown in FIG. 4 by more suitably bending the plurality of positive electrode tabs 22t.

The inclined portion 52b is a part that connects a lower end of the current collector plate connection portion 52a and an upper end of the tab bonding portion 52c. The inclined portion 52b is inclined with respect to the current collector plate connection portion 52a and the tab bonding portion 52c. The inclined portion 52b connects the current collector plate connection portion 52a and the tab bonding portion 52c so that the current collector plate connection portion 52a is positioned on a side closer to the center than the tab bonding portion 52c in the long side direction Y. Thereby, it is possible to achieve high energy density of the battery 100 by enlarging an accommodation space for the electrode body group 20. It is preferable that a lower end of the inclined portion 52b (in other words, an end of the exterior body 12 on the bottom wall 12a side) be positioned below a lower end of the positive electrode tab group 23. Thereby, it is possible to stably form the curved positive electrode tab group 23 as shown in FIG. 4 by more suitably bending the plurality of positive electrode tabs 22t.

The negative electrode current collecting unit 60 is disposed inside the battery case The negative electrode current collecting unit 60 constitutes a conductive path that electrically connects the negative electrode tab group 25 constituted by the plurality of negative electrode tabs 24t and the negative electrode terminal 40. As shown in FIG. 2, the negative electrode current collecting unit 60 includes the negative electrode first current collecting unit 61 and the negative electrode second current collecting unit 62. The negative electrode first current collecting unit 61 is an example of a current collecting unit disclosed herein. The negative electrode first current collecting unit 61 and the negative electrode second current collecting unit 62 may be formed of the same metal species as the negative electrode current collector 24c, for example, a conductive metal such as copper, a copper alloy, nickel, or stainless steel. Configurations of the negative electrode first current collecting unit 61 and the negative electrode second current collecting unit 62 may be the same as the configurations of the positive electrode first current collecting unit 51 and the positive electrode second current collecting unit 52 of the positive electrode current collecting unit 50.

As shown in FIG. 9, the negative electrode first current collecting unit 61 is attached to the inner surface of the sealing plate 14. The negative electrode first current collecting unit 61 includes a first portion 61a and a second portion 61b. The negative electrode resin member 80 is disposed between the sealing plate 14 and the first portion 61a. The first portion 61a is insulated from the sealing plate 14 by the negative electrode resin member 80. Here, the first portion 61a is electrically connected to the negative electrode terminal 40 by caulking. In the first portion 61a, a through hole 61h penetrating in the up-down direction Z is formed at a position corresponding to the terminal draw-out hole 19 of the sealing plate 14. As shown in FIG. 6, the negative electrode second current collecting unit 62 includes a current collector plate connection portion 62a which is electrically connected to the negative electrode first current collecting unit 61, an inclined portion 62b, and a tab bonding portion 62c which is attached to the negative electrode tab group 25 and electrically connected to the plurality of negative electrode tabs 24t. The current collector plate connection portion 62a includes a concave portion 62d connected to the tab bonding portion 62c. The concave portion 62d is provided with a through hole 62e penetrating in the short side direction X.

Although the illustration is omitted, the negative electrode first current collecting unit 61 is bonded to the caulking portion 40c of the negative electrode terminal 40. At a boundary portion between the caulking portion 40c and the negative electrode first current collecting unit 61, a bonding portion (for example, welding bonding portion) is formed similarly to the positive electrode side. It is preferable that at a boundary portion between the negative electrode terminal 40 and the negative electrode first current collecting unit 61, the bonding portion be formed.

As shown in FIG. 2, the positive electrode resin member 70 is disposed inside the battery case 10. The positive electrode resin member 70 is disposed between the electrode body group 20 and an inner surface of the battery case 10 (in detail, the inner surface of the sealing plate 14) in the up-down direction Z. As shown in FIG. 9, the positive electrode resin member 70 is disposed at least between the battery case 10 and the positive electrode first current collecting unit 51, and insulates the sealing plate 14 and the positive electrode first current collecting unit 51 from each other. Meanwhile, detailed description will be given below with the positive electrode resin member 70 as an example, but the negative electrode resin member 80 can also be configured in the same manner.

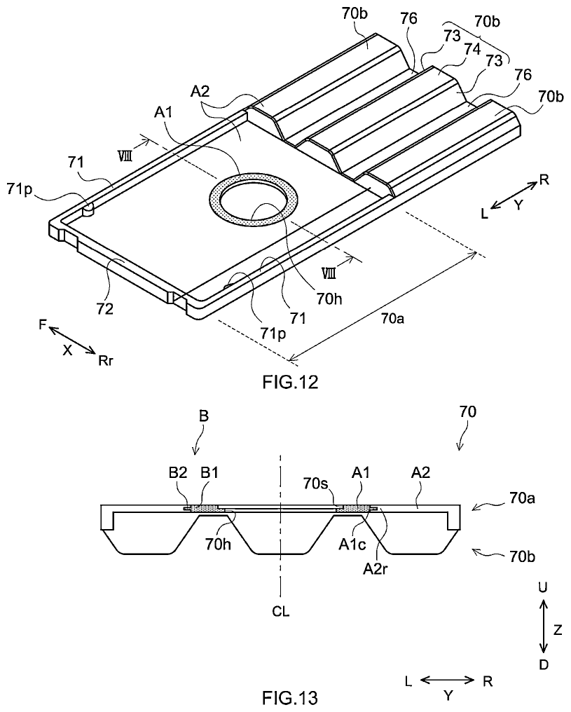

FIG. 12 is a perspective view schematically showing the positive electrode resin member 70. FIG. 13 is a cross-sectional view taken along a line XIII-XIII in FIG. 12. Note that in FIG. 13, the hatching is omitted so that each region can be distinguished easily. As shown in FIG. 12 and FIG. 13, the positive electrode resin member 70 includes a base portion and a plurality of protrusion portions 70b. As shown in FIG. 9, the plurality of protrusion portions 70b are provided to be closer to the center side of the sealing plate 14 (the right side in FIG. 8) than the base portion 70a in the long side direction Y.

As shown in FIG. 10, the base portion 70a is a part disposed between the sealing plate 14 and the first portion 51a of the positive electrode first current collecting unit 51 in the up-down direction Z. The base portion 70a extends horizontally along the first portion 51a of the positive electrode first current collecting unit 51. As shown in FIG. 12, here, the base portion 70a includes a through hole 70h penetrating in the up-down direction Z, a pair of long side walls 71 provided at both ends in the short side direction X, a short side wall 72 provided at one end (the left end in FIG. 12) in the long side direction Y, and a pair of convex portions 71p.

As shown in FIG. 11, the through hole 70h is formed at a position corresponding to the terminal draw-out hole 18 of the sealing plate 14. Around the through hole 70h, a step is provided in order to mount the sealing plate 14 thereon. The shaft portion 30a of the positive electrode terminal 30 and a shaft portion 90a of the gasket 90 are inserted into the through hole 70h. The through hole 70h is an example of a first through hole disclosed herein. The positive electrode resin member 70 is fixed to the sealing plate 14 since the positive electrode terminal 30 is caulked and bonded by welding here. As shown in FIG. 12, the pair of long side walls 71 extend in a band shape in the long side direction Y. The pair of long side walls 71 are disposed along the long side walls 12b of the exterior body 12. The short side wall 72 extends in a band shape in the short side direction X. The short side wall 72 connects one-side ends of the pair of long side walls 71 (the left end in FIG. 11).

Here, the convex portions 71p are parts for suppressing the movement (deviation) of the positive electrode resin member 70 from a predetermined arrangement position. Specifically, the convex portions 71p are parts for suppressing the rotation of the positive electrode resin member 70 in a plane parallel to the sealing plate 14 centering on a caulk portion. The convex portions 71p protrude from the sealing plate 14 side to the electrode body group 20. The pair of convex portions 71p are provided to hold both ends of the positive electrode first current collecting unit 51 in the short side direction X therebetween.

The protrusion portions 70b protrude closer to the side of the electrode body group 20 than the base portion 70a. The protrusion portions 70b protrude to be closer to the electrode body group 20 than a lower surface of the first portion 51a of the positive electrode current collecting unit 50. When such protrusion portions 70b are provided, the electrode body group 20 (specifically, the electrode bodies 20a, 20b, and 20c) is not likely to move greatly toward the sealing plate 14 inside the battery case 10. Thus, it is possible to suppress the damage of the electrode body group 20. As shown in FIG. 2, the protrusion portions 70b may be disposed on a side closer to the positive electrode tab group 23 than a center M of the electrode body group 20 in the long side direction Y. In other words, it is preferable that the protrusion portions 70b be disposed at positions (outer side) distant from the center M of the electrode body group 20 in the long side direction Y by 0.25 La or more when the length of the electrode body group 20 in the long side direction Y is La.

As shown in FIG. 3, here, the number of protrusion portions 70b is the same as the number of electrode bodies 20a, 20b, and 20c constituting the electrode body group 20. That is, the number is three. It is preferable that the plurality of protrusion portions 70b be formed. Thereby, the electrode bodies 20a, 20b, and 20c and the protrusion portions 70b can be more reliably made to face each other. Here, the protrusion portions 70b face the curved portions 20r of the electrode bodies 20a, 20b, and 20c constituting the electrode body group 20. However, the number of protrusion portions 70b may be different from the number of electrode bodies constituting the electrode body group 20, and may be, for example, one. The protrusion portions 70b are not essential members, and can also be omitted in other embodiments.

As shown in FIG. 3, the plurality of protrusion portions 70b do not abut on the electrode bodies 20a, 20b, and 20c constituting the electrode body group 20 in the state of the battery 100. The plurality of protrusion portions 70b are disposed at positions apart from the electrode bodies 20a, 20b, and 20c. A length Ha of the electrode body 20a is smaller than a distance Hb from a lower end of the protrusion portion 70b to the bottom wall 12a of the exterior body 12 in the up-down direction Z (that is, Ha<Hb). Thereby, even when vibration, an impact, or the like is applied during the use of the battery 100, it is possible to suppress the damage of the electrode bodies 20a, 20b, and 20c due to rubbing between the protrusion portions 70b and the electrode bodies 20a, 20b, and 20c. A shortest distance SD between the protrusion portion 70b and the electrode bodies 20a, 20b, and 20c may be approximately 0.1 mm or more. However, in other embodiments, the protrusion portions 70b and the electrode bodies 20a, 20b, and 20c may come into contact with each other in a state where the sealing plate 14 is disposed above the exterior body 12.

As shown in FIG. 12, the protrusion portion 70b is formed substantially in a U shape in a cross-sectional view. When the protrusion portion 70b is formed to have such a shape, a load applied to the positive electrode tab group 23 can be effectively reduced by avoiding the concentration of stress even when the electrode bodies 20a, 20b, and 20c are moved to the side of the sealing plate 14 due to vibration, an impact, or the like being applied during the use of the battery 100. Each of the plurality of protrusion portions 70b includes a pair of vertical walls 73 and a lower horizontal wall 74.

The pair of vertical walls 73 extend in parallel in the long side direction Y. The pair of vertical walls 73 extend obliquely downward toward the electrode bodies 20a, 20b, and (in other words, toward the bottom wall 12a of the exterior body 12). The pair of vertical walls 73 are formed in a tapered shape in which the diameters thereof become smaller toward the electrode bodies 20a, 20b, and 20c. The lower horizontal wall 74 extends in the long side direction Y. The lower horizontal wall 74 connects lower ends of the pair of vertical walls 73, in other words, ends on the sides of the electrode bodies 20a, 20b, and 20c. The lower horizontal wall 74 is a part of the protrusion portion 70b that is closest to the electrode body group 20. A width Tb of the lower horizontal wall 74 in the short side direction X is preferably 0.4 times or more and more preferably 0.55 times or more a width Ta of each of the electrode bodies 20a, 20b, and 20c. Here, a surface of the lower horizontal wall 74 on the sides of the electrode bodies 20a, 20b, and 20c is flat. However, the surface of the lower horizontal wall 74 may be formed in a shape along the outer surfaces (upper surfaces) of the electrode bodies 20a, 20b, and 20c, for example, a curved shape along the curved portions

As shown in FIG. 3, a region surrounded by the vertical walls 73 of the protrusion portions 70b and the electrode bodies 20a, 20b, and 20c, specifically a region surrounded by the vertical walls 73 of the adjacent protrusion portions 70b and the curved portions 20r of the electrode bodies 20a, 20b, and 20c communicates with the gas exhaust valve 17. Such a region is a gas flow path space S in which a gas generated inside the battery case 10, for example, a gas generated from end faces (end faces in the long side direction Y in FIG. 7) of the electrode bodies 20a, 20b, and 20c flows toward the gas exhaust valve 17. The gas generated inside the battery case 10 (for example, inside the electrode body group 20) easily moves to the gas exhaust valve 17 side by the gas flow path space S being secured, and thus it is possible to smoothly operate the gas exhaust valve 17. In addition, the generated gas can be efficiently discharged from the gas exhaust valve 17.

As shown in FIG. 12, the adjacent protrusion portions 70b are connected to each other by an upper horizontal wall 76 in the short side direction X. The upper horizontal wall 76 extends in the long side direction Y. The upper horizontal wall 76 extends in parallel with the pair of vertical walls 73. The upper horizontal wall 76 connects ends of the vertical walls 73 of the adjacent protrusion portions 70b on the side of the sealing plate 14 (front and back ends in FIG. 12). The upper horizontal wall 76 is connected to the base portion 70a.

The positive electrode resin member 70 is formed of a resin material having resistance to an electrolytic solution to be used (electrolytic resistance) and an electrical insulating property. The positive electrode resin member 70 includes a first region A1 made of a first material and a second region A2 made of a second material. The positive electrode resin member 70 here is formed of the first region A1 and the second region A2. That is to say, the positive electrode resin member 70 includes two different members. The first region A1 and the second region A2 are formed integrally. Although not particularly limited, it is preferable that the first region A1 and the second region A2 be integrated by at least one method among two-color molding, insertion, press fitting, adhesion, and welding. It is preferable that the positive electrode resin member 70 be an integrally molded product (for example, two-color molded product). Thereby, it is possible to reduce the number of members to be used as compared to a case where the first region A1 and the second region A2 are configured as separate members, and to realize a reduction in cost. In addition, the positive electrode resin member 70 can be prepared more easily.

The first region A1 is provided on a peripheral edge of the through hole 70h. The first region A1 here forms a portion of the base portion 70a. On the other hand, the second region A2 is provided on an outer peripheral side of the first region A1. The second region A2 forms a portion of the base portion 70a other than the first region A1, and the entire protrusion portions 70b. In other words, the first through hole 70h, the first region A1, and a portion of the second region A2 are disposed at the base portion 70a, and a portion of the second region A2 is disposed at the protrusion portions 70b.

The first region A1 is a region that requires higher heat resistance compared with the second region A2. Thus, the first material of the first region A1 has a higher melting point than the second material of the second region A2. Therefore, burning and melting of the positive electrode resin member 70 due to a heat effect can be suppressed. The melting point of the first material is preferably 150° C. or more, more preferably 200° C. or more, and particularly preferably 250° C. or more. Usually, as the melting point of the material is higher, the cost thereof is higher and thus, the melting point of the first material may be, for example, 400° C. or less, 350° C. or less, or 300° C. or less considering balance with the cost.

Although the first material is not limited in particular as long as the melting point thereof is higher than that of the second material, preferable examples include super engineering plastics with the heat resistance of 150° C. or more. Specific examples thereof include polyphenylene sulfide (PPS), a fluorinated resin such as polytetrafluoroethylene (PTFE) and tetrafluoroethylene-perfluoroalkoxy ethylene copolymer (PFA), polyether ether ketone (PEEK), and the like. Among these, from the viewpoints of the cost and the like, PPS, PTFE, and PFA are preferable and PPS is particularly preferable. The first material may be an amorphous resin without a glass transition point. The first material here is PPS. The first material may be a resin composition including PPS as a main component (component whose content ratio is the highest on a mass basis) and further containing elastomer. Table 1 indicates characteristics of the major resin materials.

TABLE 1

| | | | | Hardness |
|---|---|---|---|---|
| | | | | (Rockwell |
| Resin | Melting point | Compressive | Izod impact | hardness, |
| material | (° C.) | strength (MPa) | strength (J/m) | HRR) |
| PPS | 290 | 110 | 18 | 123 |
| PEEK | 343 | 125 | 77 | 99-107 |
| PTFE | 327 | 12 | 160 | 20 |
| PE (low | 95-130 | — | Not destroyed | — |
| density) | | | | |
| PE (high | 120-140 | 19-25 | 22-216 | — |
| density) | | | | |

Note that the shaft portion 90a of the gasket 90 here is inserted into the through hole 70h. Thus, the first region A1 is not required to have sealability. The first region A1 is a region that is not brought into contact with the electrode body group 20 even when vibration, an impact, or the like is applied during the use of the battery 100. Therefore, the first region A1 may have low impact resistance.

The second region A2 is a region that requires higher impact resistance compared with the first region A1. The second region A2 may have low heat resistance. Usually, as the resin has a lower melting point, the resin is more flexible and elastically deformed more easily and has the excellent impact resistance. Thus, the second material of the second region A2 has a lower melting point than the first material of the first region A1. Therefore, the impact resistance of the positive electrode resin member 70 can be improved. Thus, even if the impact is applied on the battery 100 due to the drop or the like and the electrode body group 20 collides with the second region A2, the positive electrode resin member 70 is not easily broken. In addition, since the thickness of the positive electrode resin member 70 does not need to be increased in order to prevent the break thereof, the flexibility of the second region A2 can be easily maintained.

The difference between the melting point of the second material and that of the first material may be generally 50° C. or more, for example 100° C. or more, and moreover 150° C. or more. The melting point of the second material is preferably 200° C. or less and more preferable 150° C. or less. The melting point of the second material may be for example 80° C. or more, 90° C. or more, or 100° C. or more. Although the second material is not limited in particular as long as the melting point thereof is lower than that of the first material, preferable examples include general purpose plastics. Specific examples thereof include a polyolefin resin such as polyethylene (PE) or polypropylene (PP). The second material may be a crystalline resin with a glass transition point. The second material here is PE. The general purpose plastic usually costs less than the super engineering plastic, and for example, the material cost can be about one tenth the cost of the super engineering plastic. Thus, the cost can be reduced. Moreover, the pressure reception area with the electrode body group 20 can be increased at low cost by lengthening the size of the protrusion portion 70b in the long side direction Y compared with the conventional one.

It is preferable that the second region A2 have higher impact strength than the first region A1. Thus, even if the electrode body group 20 collides with the second region A2, the positive electrode resin member 70 is more resistant against the breakage. The impact strength of the second region A2 is preferably 20 Jim or more, more preferably 30 Jim or more, and may be 50 Jim or more, for example. The difference between the impact strength of the second region A2 and that of the first region A1 is preferably 10 Jim or more, more preferably 20 Jim or more, and may be 50 Jim or more, for example. Note that the term “impact strength” in the present specification refers to a value based on an Izod impact strength test (notched Izod) conforming to JIS K7110:1999 “Plastics—Determination of Izod impact strength”.

It is preferable that the hardness of the second region A2 be smaller than that of the first region A1. Thus, even if the electrode body group 20 collides with the second region A2, the positive electrode resin member 70 is more resistant against the breakage. The hardness of the second region A2 is preferably 50 or less, and more preferably 20 or less. The difference between the hardness of the second region A2 and that of the first region A1 is preferably 50 or more, more preferably 80 or more, and may be 100 or more, for example. The hardness of the first region A1 is preferably 90 or more and 100 to 150, for example. Note that the term “hardness” in the present specification refers to Rockwell hardness (abbreviation: HRR, unit: none) based on “Rockwell hardness test (R scale)” conforming to JIS K7202.

In a plan view, when the area of the base portion 70a is 100%, the ratio of the area of the first region A1 is preferably 40% or less, more preferably 30% or less, and still more preferably 20% or less. In a plan view, when the area of the base portion 70a is 100%, the ratio of the area of the second region A2 is preferably 60% or more, more preferably 70% or more, and still more preferably 80% or more. It is preferable that the protrusion portion 70b do not include the first region A1. It is preferable that the protrusion portion 70b be formed of the second region A2. Thus, the effect of the art disclosed herein can be obtained at a higher level.

From the viewpoints of reducing the cost and the like, it is preferable that the volume of the second region A2 be larger than that of the first region A1. Although not particularly limited, when a total of the positive electrode resin member 70 is 100% by mass, the ratio of the second region A2 is preferably 60% or more by mass, more preferably 70% or more by mass, particularly preferably 80% or more by mass, and 90% or more by mass, for example.

In a cross-sectional view in a thickness direction (the up-down direction Z in FIG. 13), it is preferable that the first region A1 totally cover a side wall of the through hole 70h. That is to say, it is preferable that the first region A1 be provided on the entire portion of the positive electrode resin member 70 that is in contact with the positive electrode terminal 30 (in detail, shaft portion 30a).

As shown in FIG. 13, there is no gap at a boundary portion (connection portion) B between the first region A1 and the second region A2, in other words, a bonding interface between the first material and the second material, and the first region A1 and the second region A2 are continuously formed. In the present embodiment, at the boundary portion B, the first region A1 and the second region A2 are combined like stairs (steps). Specifically, in the cross-sectional view in the thickness direction of the positive electrode resin member 70 (the up-down direction Z in FIG. 13), the first region A1 includes a convex portion A1c, the second region A2 includes a concave portion A2r, and the boundary portion B has a concavo-convex shape. It is preferable that the boundary portion B between the first region A1 and the second region A2 have a tube shape, and the diameters thereof change from a small diameter to a large one or from a large diameter to a small one in a middle portion in the thickness direction.

In this way, it is preferable that the boundary portion B include a tube portion B1 that is a region extending in the thickness direction and a plane portion B2 that is a region extending in a direction that is inclined with respect to the thickness direction. Thus, for example, even if the first material and/or the second material is the crystalline resin such as PP, PE, or PPS and chemical bonding does not occur easily, the first material and the second material can be physically bonded easily by an anchor effect. Moreover, even if a crack or the like is caused at the boundary portion B and the electrolytic solution soaks into the crack, creeping discharge can be suppressed by properly keeping a creeping distance from the sealing plate 14 to the first portion 51a of the positive electrode current collecting unit 50.

That is to say, by the art disclosed herein, even if the positive electrode resin member collides with the electrode bodies 20a, 20b, and 20c, the positive electrode resin member is not easily broken. Therefore, if the thickness of the positive electrode resin member 70 is reduced in order to secure the battery capacity, the creeping distance between the sealing plate 14 and the first portion 51a of the positive electrode current collecting unit 50 can be kept properly and electric leakage due to the creeping discharge can be prevented. Moreover, since the first region A1 and the second region A2 are combined like stairs at the boundary portion B, a long creeping distance can be secured compared with a case where the boundary portion B has a linear shape. Thus, even if a crack or the like is caused at the boundary portion B, a gap is made between the first region A1 and the second region A2, and the electrolytic solution soaks into the crack, a decline in the capacity due to the electric leakage can be suppressed. From the viewpoint of obtaining this effect at the high level, it is desired to form the boundary portion B so that the creeping distance is 1.2 times or more or preferably 1.5 times or more as long as that in the case where the boundary portion B has the linear shape in the thickness direction.

Furthermore, in the integral molding (for example, two-color molding), first, the first material with the high melting point may be primarily molded to form the first region A1 and next, the second material with the low melting point may be secondarily molded at a lower temperature than that in the primary molding to form the second region A2 by using the primary molded product as a mold. In this case, if the convex portion A1c is formed on the first region A1 in the primary molding, the second material easily flows to the boundary portion B to surround the convex portion A1c in the secondary molding. Therefore, the creeping distance can be easily secured and moreover, the moldability can be improved.

As shown in FIG. 2, the negative electrode resin member 80 is disposed to be symmetrical to the positive electrode resin member 70 with respect to the center M of the electrode body group 20 in the long side direction Y. A configuration of the negative electrode resin member 80 may be the same as that of the positive electrode resin member 70. Here, similarly to the positive electrode resin member 70, the negative electrode resin member 80 includes a base portion (not shown) disposed between the sealing plate 14 and the negative electrode first current collecting unit 61, and a plurality of protrusion portions 80b (see FIG. 9). It is preferable that the battery 100 include both the positive electrode resin member 70 and the negative electrode resin member 80. Thereby, even when vibration, an impact, or the like is applied during the use of the battery 100, it becomes easy to maintain the electrode body group 20 and the sealing plate 14 in parallel (the state in FIG. 2).

<Manufacturing Method for Sealing Plate Assembly>

The sealing plate assembly shown in FIG. 8 and FIG. 9 can be manufactured by fixing the positive electrode terminal 30, the positive electrode first current collecting unit 51, the positive electrode resin member 70, the negative electrode terminal 40, the negative electrode first current collecting unit 61, and the negative electrode resin member 80 to the sealing plate 14. The positive electrode terminal 30, the positive electrode first current collecting unit 51, and the positive electrode resin member 70 are fixed to the sealing plate 14 by, for example, caulking (riveting). As shown in FIG. 11, caulking is performed by interposing the gasket 90 between the outer surface of the sealing plate 14 and the positive electrode terminal 30 and interposing the positive electrode resin member 70 between the inner surface of the sealing plate 14 and the positive electrode first current collecting unit 51. Meanwhile, a material of the gasket 90 may be the same as that of the positive electrode resin member 70, for example.

In detail, the shaft portion 30a of the positive electrode terminal 30 before the caulking is inserted into the through hole 90h of the gasket 90, the terminal draw-out hole 18 of the sealing plate 14, the through hole 70h of the positive electrode resin member 70, and the through hole 51h of the positive electrode first current collecting unit 51 in this order from above the sealing plate 14 so as to protrude below the sealing plate 14. Then, a portion of the shaft portion 30a which protrudes downward from the sealing plate 14 is caulked so that a compressive force is applied in the up-down direction Z. Thereby, the caulking portion is formed at a tip end of the positive electrode terminal 30 (the lower end portion in FIG. 2). By such caulking, the gasket 90, the sealing plate 14, the positive electrode resin member and the positive electrode first current collecting unit 51 are integrally fixed to the sealing plate 14, and the terminal draw-out hole 18 is sealed.

Next, the caulking portion 30c and the positive electrode first current collecting unit 51 are metallurgically bonded. Thus, the bonding portion 30j is formed at the boundary portion between the positive electrode terminal 30 and the positive electrode first current collecting unit 51. For example, the bonding portion 30j is formed by welding such as ultrasonic welding, resistance welding, or laser welding. Thus, the conduction reliability can be improved.

The negative electrode terminal 40, the negative electrode first current collecting unit 61, and the negative electrode resin member 80 can be fixed to the sealing plate 14 in the same manner as on the above-described positive electrode side. Thereby, the caulking portion 40c is formed at a tip end of the negative electrode terminal 40 (the lower end portion in FIG. 2). In addition, the bonding portion (not shown) is formed at the boundary portion between the negative electrode terminal 40 and the negative electrode first current collecting unit 61.

<Application of Battery 100>

The battery 100 can be used for various purposes, but can be suitably used in an application in which an external force such as vibration or an impact may be applied during the use thereof, for example, as a power source (driving power source) for a motor mounted on a moving body (typically, a vehicle such as a passenger car or a truck). Although the type of vehicles is not particularly limited, examples thereof may include a plug-in hybrid electric vehicle (PHEV), a hybrid electric vehicle (HEV), a battery electric vehicle (BEV), and the like. The battery 100 can also be suitably used as an assembled battery in which a plurality of batteries 100 are arranged in a predetermined arrangement direction and a load is applied from the arrangement direction by a restraint mechanism. Even in a state where the load is applied by the restraint mechanism, it is preferable that the protrusion portions 70b of the positive electrode resin member 70 and/or the protrusion portions 80b of the negative electrode resin member 80 do not abut on the electrode bodies 20a, 20b, and 20c.

Although some embodiments of the present disclosure have been described above, the above-described embodiments are merely examples. The present disclosure can be implemented in various other forms. The present disclosure can be implemented on the basis of the contents disclosed in the present specification and common general technical knowledge in the relevant field. The techniques described in the claims include various modifications and changes of the embodiments illustrated above. For example, a portion of the above-described embodiment can also be replaced with another modification, and another modification can also be added to the above-described embodiment. When the technical feature is not described as essential, it can be deleted as appropriate.

<Modifications>

For example, in the aforementioned embodiment shown in FIG. 13, in the cross-sectional view in the thickness direction of the positive electrode resin member 70 (the up-down direction Z in FIG. 13), the first region A1 covers the entire side wall of the through hole 70h. In addition, the first region A1 includes the convex portion A1c, the second region A2 includes the concave portion A2r, and the boundary portion B has the concavo-convex shape. However, the present disclosure is not limited to this example. The first region A1 does not need to cover the entire side wall of the through hole 70h. Moreover, it is not always necessary that the boundary portion B have the concavo-convex shape, and it may have an arbitrary shape.

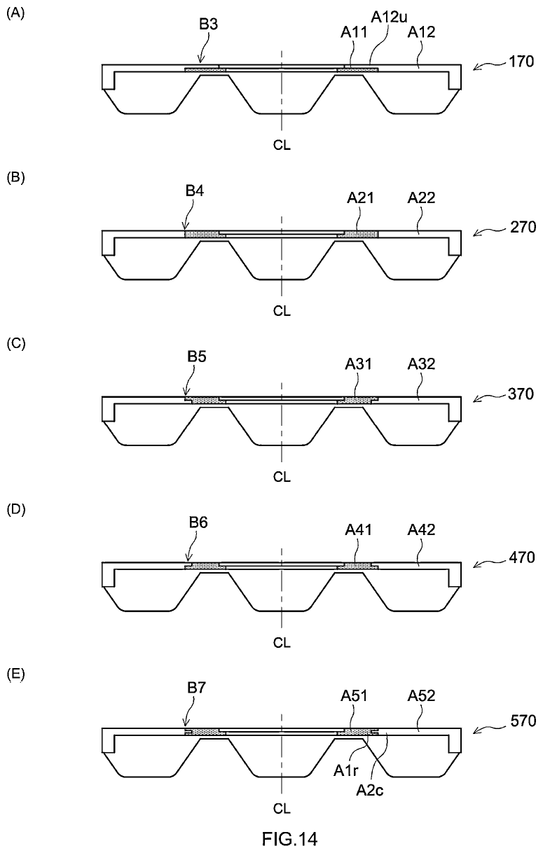

FIG. 14A is a diagram corresponding to FIG. 13 and shows a positive electrode resin member 170 according to a first modification. The positive electrode resin member 170 is a preferable example in a case where the first material and/or the second material is the amorphous resin in which the chemical bonding easily occurs. In the present modification, the positive electrode resin member 170 includes a first region A11 and a second region A12. The first region A11 covers a portion of the side wall of the through hole 70h in the thickness direction. The second region A12 includes a concave portion A12u with a ring shape that extends to the peripheral edge of the through hole 70h, which is different from the aforementioned embodiment. The first region A11 is disposed inside the concave portion A12u. By the shape in the present modification, even if a crack or the like is caused at a boundary portion B3 between the first region A11 and the second region A12, the creeping distance can be kept properly and the electric leakage due to the creeping discharge can be prevented similarly to the aforementioned embodiment.

FIG. 14B is a diagram corresponding to FIG. 13 and shows a positive electrode resin member 270 according to a second modification. The positive electrode resin member 270 is a preferable example in the case where the first material and/or the second material is the amorphous resin in which the chemical bonding easily occurs. In the present modification, the positive electrode resin member 270 includes a first region A21 and a second region A22. A boundary portion B4 between the first region A21 and the second region A22 has a linear shape, and extends in a vertical direction here. For example, if the positive electrode resin member 70 is sufficiently thick, the boundary portion B4 may have the linear shape as described in the present modification.

FIG. 14C and FIG. 14D are diagrams corresponding to FIG. 13 and show positive electrode resin members 370 and 470 according to third and fourth modifications, respectively. The positive electrode resin members 370 and 470 are a preferable example in the case where the first material and/or the second material is the amorphous resin in which the chemical bonding easily occurs. In the present modifications, the positive electrode resin member 370 includes a first region A31 and a second region A32, and the positive electrode resin member 470 includes a first region A41 and a second region A42. A boundary portion B5 between the first region A31 and the second region A32 or a boundary portion B6 between the first region A41 and the second region A42 has a shape like stairs (steps). For example, if the first region A41 and the second region A42 stick firmly to each other without separation in transportation of the positive electrode resin member 370 or 470 or assembly of the battery 100, the concavo-convex shape as described in the present modifications may be omitted.

FIG. 14E is a diagram corresponding to FIG. 13 and shows a positive electrode resin member 570 according to a fifth modification. In the present modification, the positive electrode resin member 570 includes a first region A51 and a second region A52. A boundary portion B7 between the first region A51 and the second region A52 has a concavo-convex shape. Contrary to the aforementioned embodiment, in the boundary portion B7, the first region A51 includes a concave portion A1r and the second region A52 includes a convex portion A2c. For example, in the secondary molding by the two-color molding, in a case where the second material smoothly flows to the concave portion A1r sufficiently, the first region A51 side may include the concave portion A1r as described in the present modification.

As described above, the following items are given as specific aspects of the art disclosed herein.

Item 1: The battery including: the electrode body that includes the positive electrode and the negative electrode; the battery case that accommodates the electrode body; the current collecting unit that is disposed inside the battery case and electrically connected to the positive electrode or the negative electrode; the terminal that is electrically connected to the current collecting unit inside the battery case and attached to the battery case; and the resin member that is disposed between the inner surface of the battery case and the electrode body, in which the resin member includes the first through hole, the current collecting unit includes the second through hole, the terminal includes the shaft portion that is inserted into the first through hole and the second through hole, and the bonding portion at one end of the terminal, the bonding portion being bonded to the current collecting unit, the resin member includes the first region that is provided on the peripheral edge of the first through hole and the second region that is provided on the outer peripheral side of the first region and formed with the first region integrally, and the first material of the first region has the higher melting point than the second material of the second region.
Item 2: The battery according to Item 1, in which the melting point of the first material of the first region is 200° C. or more.
Item 3: The battery according to Item 1 or 2, in which the second region has the higher impact strength based on the Izod impact strength test than the first region.
Item 4: The battery according to any one of Items 1 to 3, in which the impact strength of the second region based on the Izod impact strength test is 30 Jim or more.
Item 5: The battery according to any one of Items 1 to 4, in which the boundary portion between the first region and the second region includes the region extending in the thickness direction of the resin member and the region extending in the direction that is inclined with respect to the thickness direction.
Item 6: The battery according to any one of Items 1 to 5, in which when the total of the resin member is 100% by mass, the ratio of the second region is 60% or more by mass.
Item 7: The battery according to any one of Items 1 to 6, in which the resin member includes the base portion that is disposed along the surface to which the terminal of the battery case is attached and the protrusion portion that protrudes closer to the side of the electrode body than the surface of the current collecting unit on the side of the electrode body, the first through hole, the first region, and the portion of the second region are disposed at the base portion, and the portion of the second region is disposed at the protrusion portion.

Although the preferred embodiment of the present application has been described thus far, the foregoing embodiment is only illustrative, and the present application may be embodied in various other forms. The present application may be practiced based on the disclosure of this specification and technical common knowledge in the related field. The techniques described in the claims include various changes and modifications made to the embodiment illustrated above. Any or some of the technical features of the foregoing embodiment, for example, may be replaced with any or some of the technical features of variations of the foregoing embodiment. Any or some of the technical features of the variations may be added to the technical features of the foregoing embodiment. Unless described as being essential, the technical feature(s) may be optional.

### REFERENCE SIGNS LIST

10 Battery case
20 Electrode body group
20b, 20c Electrode body
30 Positive electrode terminal (terminal)
40 Negative electrode terminal (terminal)
50 Positive electrode current collecting unit
51 Positive electrode first current collecting unit (current collecting unit)
52 Positive electrode second current collecting unit
60 Negative electrode current collecting unit
70, 170, 270, 370, 470, 570 Positive electrode resin member (resin member)
A1 First region
A2 Second region
70a Base portion
70b Protrusion portion
70h Through hole
80 Negative electrode resin member (resin member)
100 Battery

What is claimed is:

1. A battery comprising:
an electrode body that includes a positive electrode and a negative electrode;
a battery case that accommodates the electrode body;
a current collecting unit that is disposed inside the battery case and electrically connected to the positive electrode or the negative electrode;
a terminal that is electrically connected to the current collecting unit inside the battery case and attached to the battery case; and
a resin member that is disposed between an inner surface of the battery case and the electrode body, wherein
the resin member includes a first through hole,
the current collecting unit includes a second through hole,
the terminal includes a shaft portion that is inserted into the first through hole and the second through hole, and a bonding portion at one end of the terminal, the bonding portion being bonded to the current collecting unit,
the resin member includes a first region that is provided on a peripheral edge of the first through hole and a second region that is provided on an outer peripheral side of the first region and formed with the first region integrally, and
a first material of the first region has a higher melting point than a second material of the second region.

2. The battery according to claim 1, wherein the melting point of the first material of the first region is 200° C. or more.

3. The battery according to claim 1, wherein the second region has higher impact strength based on an Izod impact strength test than the first region.

4. The battery according to claim 3, wherein the impact strength of the second region based on the Izod impact strength test is 30 Jim or more.

5. The battery according to claim 1, wherein a boundary portion between the first region and the second region includes a region extending in a thickness direction of the resin member and a region extending in a direction that is inclined with respect to the thickness direction.

6. The battery according to claim 1, wherein when a total of the resin member is 100% by mass, a ratio of the second region is 60% or more by mass.

7. The battery according to claim 1, wherein
the resin member includes a base portion that is disposed along a surface to which the terminal of the battery case is attached and a protrusion portion that protrudes closer to a side of the electrode body than a surface of the current collecting unit on the side of the electrode body,
the first through hole, the first region, and a portion of the second region are disposed at the base portion, and
a portion of the second region is disposed at the protrusion portion.
